(19) United States
(12) Patent Application Publication
(10) Pub. No.: US 2013/0164141 A1
(43) Pub. Date: Jun. 27, 2013

(54) BLADE WITH SEMI-RIGID TRAILING EDGE

(71) Applicants: Wendy Wen-Ling Lin, Niskayuna, NY (US); Roger Drobietz, Rheine (DE)

(72) Inventors: Wendy Wen-Ling Lin, Niskayuna, NY (US); Roger Drobietz, Rheine (DE)

(73) Assignee: GENERAL ELECTRIC COMPANY, SCHENECTADY, NY (US)

(21) Appl. No.: 13/334,748

(22) Filed: Dec. 22, 2011

(51) Int. Cl. F01D 5/14; B23P 15/02

(52) U.S. Cl. 416/223 R; 29/889.7

(57) ABSTRACT

A blade with an aerodynamic blade body having a leading edge and a trailing edge is provided. The blade includes at least one flexible adaptor component having a first side coupled to the trailing edge. Further, the blade includes at least one rigid acoustic segment attached to an opposing second side of the at least one flexible adapter component for mitigating noise during fluid flow over the blade.

### BACKGROUND

The invention relates generally to blades and more particularly to wind blades.

During operation of an airfoil such as a wind rotor blade, a fan blade, or an aircraft wing, a fluid flows across the airfoil forming a boundary layer. Generally the boundary layer is laminar in the proximity of a leading edge of the airfoil and transitions to a turbulent boundary layer over the body of the airfoil. In the case of the wind blade or, the airfoil captures kinetic energy of the fluid flow and transforms the kinetic energy to rotational energy so as to turn a shaft coupling the blades to a gearbox or, if a gearbox is not used, directly to the generator. The generator then converts the rotational energy to electrical energy that may be deployed to a utility grid. However, during operation, the airfoils generate considerable noise due to interaction of a trailing edge of the airfoil with the turbulent flow in the turbulent boundary layer.

It is desirable to reduce the noise generated during operation of the airfoil while maintaining aerodynamic performance of the airfoil for maximum energy extraction.

### BRIEF DESCRIPTION

In accordance with an embodiment of the invention, a blade is provided. The blade includes an aerodynamic blade body having a leading edge and a trailing edge. The blade also includes at least one flexible adaptor component having a first side coupled to the trailing edge. Further, the blade includes at least one rigid acoustic segment attached to an opposing second side of the at least one flexible adapter component for mitigating noise during fluid flow over the blade.

In accordance with an embodiment of the invention, a flexible trailing edge adapter component for a wind blade is provided. The flexible trailing edge adapter component includes a first side portion shaped for attachment to a truncated airfoil trailing edge of the wind blade. Further, the flexible trailing edge adapter component also includes a second side portion shaped for attachment of a plurality of rigid acoustic segments.

In accordance with an embodiment of the invention, a method is provided that includes positioning a first side of at least one adaptor component over at least a portion of a trailing edge of a wind turbine blade and attaching s at least one rigid acoustic segment to an opposing second side of the adaptor component for mitigating noise during fluid flow over the wind blade. The method also includes fastening or bonding the at least one adaptor component to the trailing edge of the wind turbine blade.

### DRAWINGS

These and other features, aspects, and advantages of the present invention will become better understood when the following detailed description is read with reference to the accompanying drawings in which like characters represent like parts throughout the drawings, wherein:

FIG. 1 is cross-sectional view of an airfoil trailing edge region in accordance with an embodiment of the present invention.

FIG. 2 illustrates a blade with multiple flexible adapter components attached to a truncated trailing edge portion in accordance with an embodiment of the present invention.

FIG. 3 illustrates a perspective view of a flexible adapter component of the trailing edge region of a blade in accordance with an embodiment of the present invention.

FIG. 4 shows a trailing edge region of a blade with a rigid acoustic segment attached to a flexible adapter component in accordance with an embodiment of the present invention.

FIG. 5 shows a trailing edge region of a blade with a rigid acoustic segment attached to a flexible adapter component in accordance with another embodiment of the present invention.

FIG. 6 shows a rigid acoustic segment with a brush made from slit fiber reinforced composite tapes in accordance with another embodiment of the present invention.

FIG. 7 is a flow chart for mitigating noise in a blade in accordance with an embodiment of the present invention.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

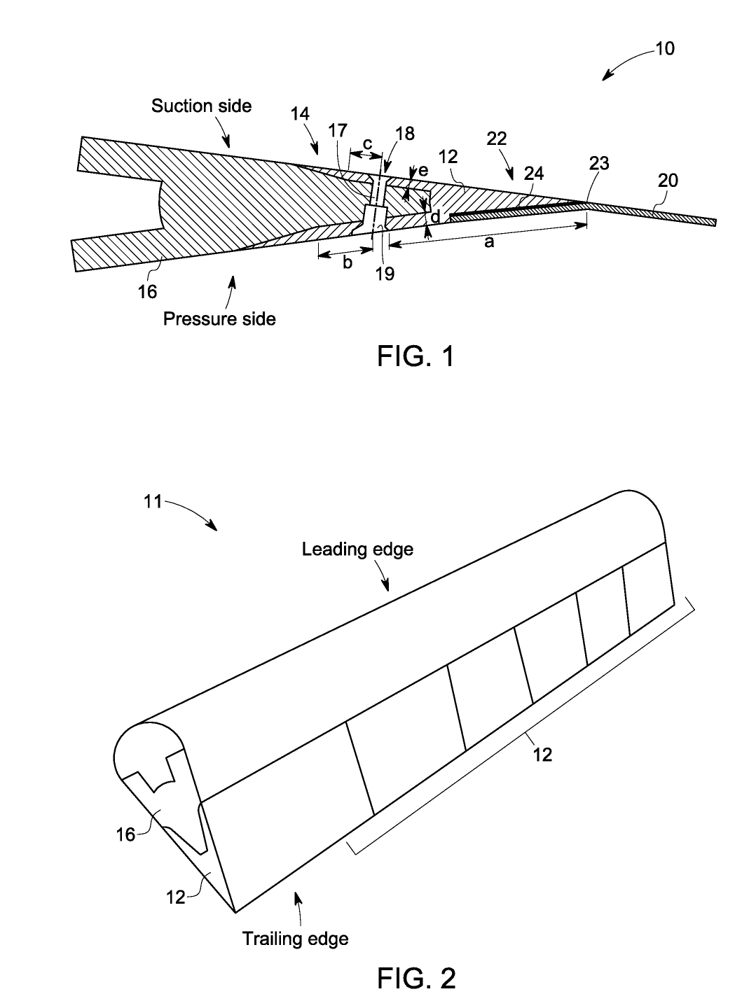

FIG. 1 is cross-sectional view of a trailing edge region 10 of a blade in accordance with an embodiment of the present invention. The blade includes an aerodynamic blade body comprising a leading edge region (not shown) and the trailing edge region 10. In one embodiment, the trailing edge region 10 includes at least one flexible adaptor component 12 having a first side 14 coupled to a truncated trailing edge portion 16 of the blade. In one embodiment, the at least one flexible adapter component 12 comprises a flexible material with a young's modulus ranging from about 0.7 MPa to about 3500 MPa. In a more specific embodiment, the flexible material of the adapter component 12 may have a young's modulus ranging from about 7 MPa to about 500 MPa. Non-limiting examples of the flexible material of the adapter component 12 include a rubber material such as polyurethane, silicone, fluorosilicone, ethylene-propylene rubber, natural rubber, neoprene, styrene-butadiene rubber, butile rubber, butadiene rubber, thermoplastic vulcanizate rubber, chlorosulphonated polyethylene rubber, nitrile, fluoroelastomer, or combinations thereof.

In the embodiment of FIG. 1, the first side 14 of the flexible adapter component 12 is mechanically attached to the truncated trailing edge portion 16 using a fastener 18. In one embodiment, the fastener 18 comprises a threaded bolt 17 that is capable of being screwed within a threaded receiver 19. As shown, the fastener 18 is sized to match the aerodynamic shape of blade body such that both ends of the fastener 18 are aligned with the surface of the flexible adapter component 12. For example, the threaded receiver 19 may include a tapered base that is matched with the surface of the flexible adapter component 12, thus ensuring that there is smooth surface of the trailing edge portion 10 for laminar boundary layer flow. In another embodiment, the fastener 18 may include locking features such as latches or dovetails. The fastener 18 may comprise an electrically insulative or insulated material for minimizing damage to the blade in case of a lightning strike, for example. Further, the trailing edge region 10 includes at least one rigid acoustic segment 20 attached to an opposing second side 22 of the at least one flexible adapter component 12 for mitigating noise during fluid flow over the blade. In one embodiment, the rigid acoustic segment 20 is attached to the flexible adapter component 12 using an adhesive material 24. The adhesive material 24 may include a tape or glue for attaching the rigid acoustic segment 20 to the flexible adapter component 12. Non-limiting examples of the adhesive material 24 include epoxies, urethanes, acrylates, and silicones. As shown in FIG. 1, the rigid acoustic segment 20 extends beyond the second side of the flexible adapter component 12. Non-limiting examples of the rigid material of the rigid acoustic segment 20 may include continuous fiber composites, long fiber composites, reinforced plastics, and metals. In one embodiment, “rigid” means that the material does not allow deflection of more than 1 mm under gravity load in the geometry of the rigid acoustic segment 20.

In one non-limiting example of an embodiment of the present invention as shown in FIG. 1, the dimensions of the flexible adapter component 12 with respect to the truncated trailing edge portion 16 and the fastener 18 are illustrated by the reference letters “a”, “b”, “c”, “d” and “e”, wherein “a” is about 100 millimeters and depicts the length of the side of the flexible adapter component 12 from the threaded receiver 19 of the fastener 18 and the edge of the flexible adapter component 12 at the pressure side of the blade. The dimension “b” is about 26 millimeters and depicts the length from center of threaded receiver 19 to a flat region of the flexible adapter component 12 that is non-tapered at the pressure side of the blade. The dimension “c” is about 16 millimeters and depicts the length from center of threaded bolt 17 to a flat region of the flexible adapter component 12 that is non-tapered at the suction side as shown. The dimension “d” is about 7 millimeters and depicts the width of the non-tapered flat region of the flexible adapter component 12 at the pressure side of the blade. The dimension “e” is about 4 millimeters and depicts the width of the non-tapered flat region of the flexible adapter component 12 at the suction side of the blade.

FIG. 2 illustrates a blade 11 with multiple flexible adapter components 12 attached to a truncated trailing edge portion 16 (as shown in FIG. 1) in accordance with an embodiment of the present invention. The blade includes a leading edge and the trailing edge having the truncated trailing edge portion attached with multiple flexible adapter components 12.

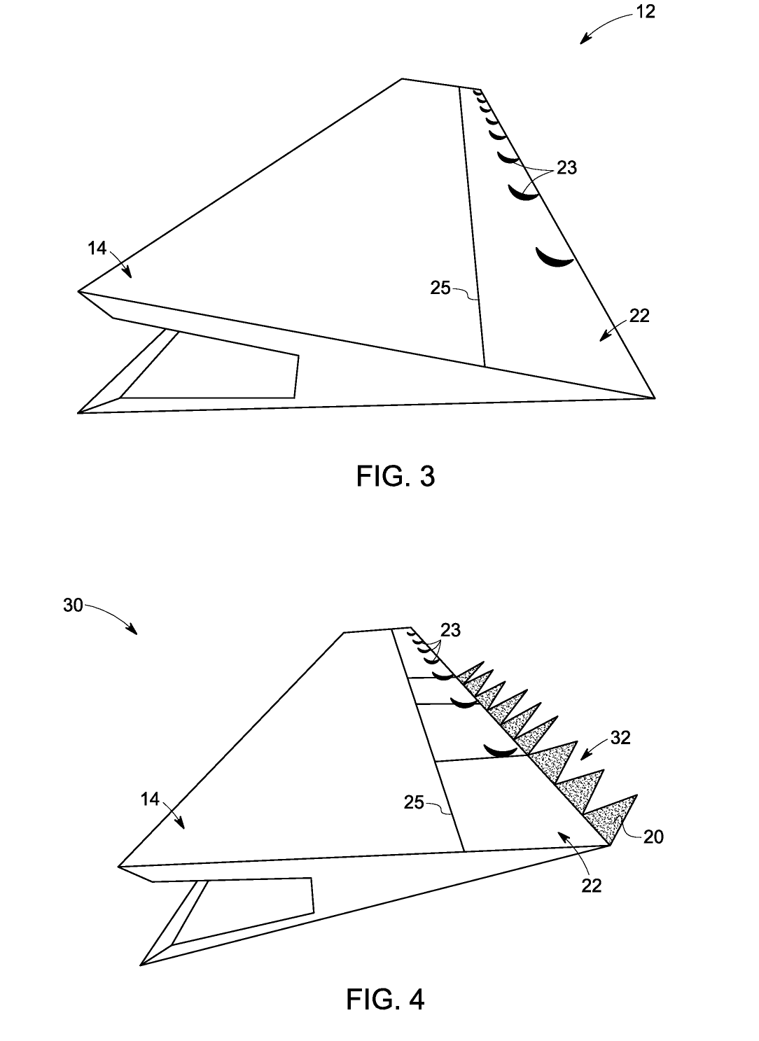

FIG. 3 illustrates a perspective view of a flexible adapter component 12 in accordance with an embodiment of the present invention. In one embodiment, the flexible adapter component 12 is fabricated in a controlled closed molding process using a low modulus flexible material for precise geometry of the adapter component 12 to provide for a close fit onto the truncated trailing edge portion 16 (FIG. 1) of the blade. In one embodiment, one or more flexible adapter components 12 may be attached to the truncated trailing edge portion 16 of the blade. In a more specific embodiment, a plurality of adapter components are used as shown in FIG. 2, and each of the flexible adapter components 12 comprises a segment length of two meters or less to permit easy handling during assembly of the blade and to reduce peak stresses at the mechanical attachment at the first side portion 14 during operation of the blade.

Also, as shown in FIG. 3, the opposing second side 22 of the flexible adapter component 12 may include a plurality of raised protrusions 23 for positioning rigid acoustic segments 20 (FIG. 1). In one embodiment, each of the raised protrusions 23 comprises one-millimeter thick raised ellipse shaped protrusion for locating the rigid acoustic segments 20. As shown, the opposing second side 22 of each of the flexible adapter component 12 may further include a recessed portion 25 for positioning the plurality of the rigid acoustic segments 20 during assembly of the blade. In one embodiment, the recessed portion 25 is one-millimeter recessed portion for attaching the rigid acoustic segments 20.

Using a low modulus material for the flexible adapter component 12 reduces stressed concentrations at the attachment points. Using mechanical fasteners enables easy replacement or repair of the flexible adaptor components. Furthermore, reductions in stressed concentrations at mechanical attachment points allow use of longer trailing edge segments and enable reduced part count or fewer trailing edge segments on each blade. An advantage of the combination of flexible adapter components 12 with rigid acoustic segments 20 is that the flexible adaptor components may mechanically decouple the rigid acoustic segments 20 from the blade. If the rigid acoustic segments are directly bonded or mechanically attached to the blade, the acoustic segment or blade interface may tend to have high stresses, especially at the segment ends and also at fastener holes. The flexible adapter may significantly reduce those stresses. In addition, the flexible adapter may allow part dimensional tolerances and easier assembly.

In one embodiment, as shown in a trailing edge region 30 of FIG. 4, the rigid acoustic segment 20 includes a stiff fiber reinforced composite serration with valleys 32. The composite serration with valleys 32 may be attached to the opposite second side 22 using a tape or adhesive similar to the adhesive material 24 of FIG. 1 at the recessed portion 25, and the serrations extend beyond the flexible adapter component 12. The fiber composite serration with valleys may be fabricated from continuous fiber composites, filled polymers, long fiber composites, or metals, or combinations thereof, for example.

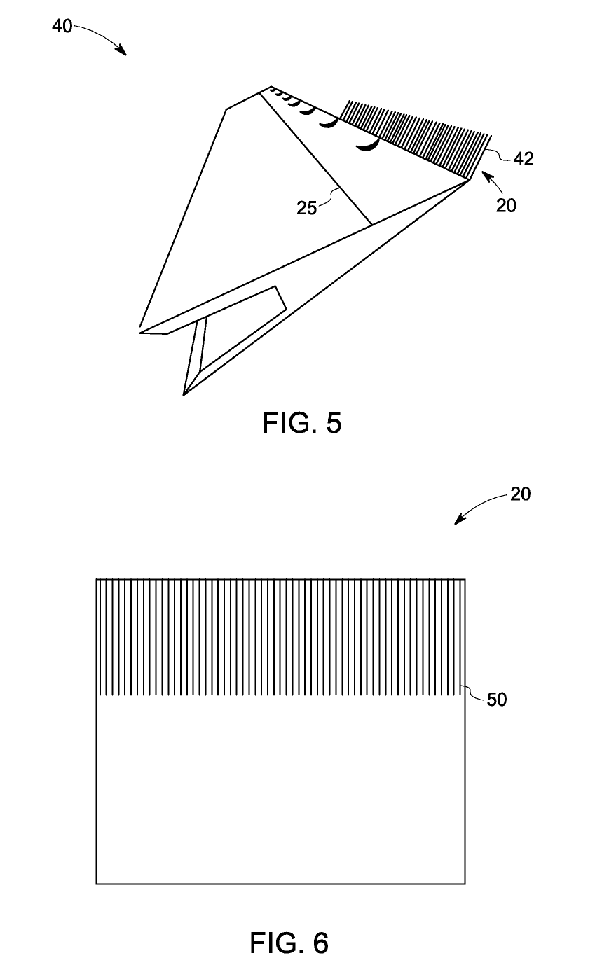

In another embodiment, as shown in a trailing edge region 40 of FIG. 5, the rigid acoustic segment 20 includes a brush 42 comprising composite bristles. The brush 42 or the composite serration with valleys 32 mitigates noise by breaking down turbulence flow at the trailing edge into smaller micro-turbulence flows.

In yet another embodiment as shown in FIG. 6, the rigid acoustic segment 20 comprises a brush 50 made from slit fiber reinforced composite tapes. Further, in one embodiment, the tape may include an assembly of filaments fabricated from continuous fiber composites, filled and non-filled polymers, metals, or combinations thereof, for example.

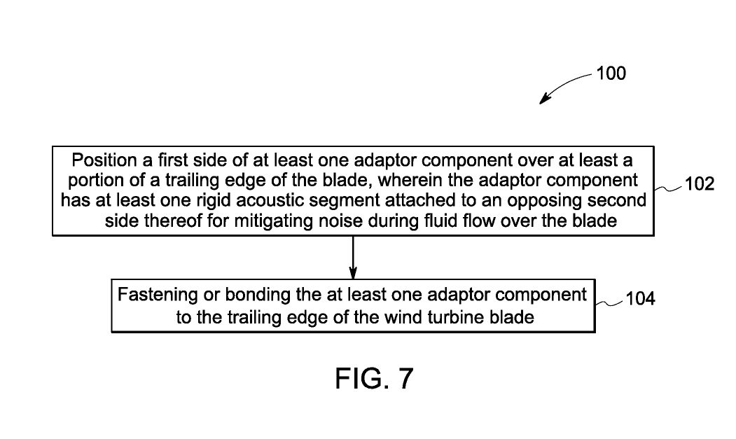

FIG. 7 is a flow chart for a method 100 for mitigating noise in a blade in accordance with an embodiment of the present invention. At step 102, the method includes positioning a first side of at least one adaptor component over at least a portion of a trailing edge of the blade. In one specific embodiment prior to attachment to the trailing edge the adaptor component has at least one rigid acoustic segment attached to an opposing second side thereof for mitigating noise during fluid flow over the blade. In another embodiment, the at least one rigid acoustic segment may be attached to the adaptor component after the adaptor component is attached to the blade. In one embodiment, the at least one acoustic segment comprises a plurality of serrated segments. In another embodiment, the at least one acoustic segment comprises a brush. At step 102, the method also includes fastening or bonding the at least one adaptor component to the trailing edge of the wind turbine blade.

Advantageously, the present blade ensures reduced stress concentrations between the truncated trailing edge and the low modulus material of the flexible adapter component. The low modulus material of the flexible adapter component also ensures reduced stresses in the rigid acoustic segment that is attached to the flexible adapter component. Moreover, the flexible adapter component may be molded to provide improved dimensional control geometry at the trailing edge of the blade. Further, the present blade allows for easy assembly of the truncated trailing edge portion with the flexible adapter component and the rigid acoustic segment on the flexible adapter component during repairing or maintenance, leading to reducing maintenance time.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional assemblies and techniques in accordance with principles of this disclosure. Of course, it is to be understood that not necessarily all such objects or advantages described above may be achieved in accordance with any particular embodiment. Thus, for example, those skilled in the art will recognize that the assemblies and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A blade comprising:
an aerodynamic blade body comprising a leading edge and a trailing edge;
at least one flexible adaptor component having a first side coupled to the trailing edge; and
at least one rigid acoustic segment attached to an opposing second side of the at least one flexible adapter component for mitigating noise during fluid flow over the blade.

2. The blade of claim 1 wherein the trailing edge comprises a truncated trailing edge.

3. The blade of claim 1 wherein the at least one flexible adaptor component is shaped to fit over at least a portion of the truncated trailing edge.

4. The blade of claim 1, wherein the at least one rigid acoustic segment extends beyond the second side of the flexible adapter component.

5. The blade of claim 1, wherein the at least one rigid acoustic segment comprises a serration, a brush comprising bristles, or a slit tape.

6. The blade of claim 1, further comprising an adhesive material for attaching the at least one rigid acoustic segment to the second side of the at least one adapter component.

7. The blade of claim 1, wherein the blade comprises a wind blade.

8. The blade of claim 1, wherein the at least one flexible adapter component comprises a flexible material with a young's modulus ranging from about 7 MPa to about 500 MPa.

9. The blade of claim 1 wherein the at least one flexible adapter component comprises polyurethane, silicone, fluorosilicone, ethylene-propylene rubber, natural rubber, neoprene, styrene-butadiene rubber, butile rubber, butadiene rubber, thermoplastic vulcanizate rubber, chlorosulphonated polyethylene rubber, nitrile, fluoroelastomer, or combinations thereof.

10. The blade of claim 1, wherein the at least one adapter component comprises a plurality of raised protrusions for positioning of the plurality of serrated segments.

11. The blade of claim 10, wherein the at least one adapter component comprises a plurality of recessed portions for further positioning the plurality of serrated segments.

12. The blade of claim 1 further comprising at least one fastener coupling the at least one adaptor component to the trailing edge.

13. The blade of claim 12, wherein the at least one fastener comprises an electrically insulative or insulated material.

14. The blade of claim 12, wherein the at least one fastener is sized to match an aerodynamic shape of the blade body.

15. A flexible trailing edge adapter component for a wind blade; the trailing edge adapter component comprising:
a first side portion shaped for attachment to a truncated airfoil trailing edge of the wind blade; and
a second side portion shaped for attachment of a plurality of rigid acoustic segments.

16. The trailing edge adapter component of claim 15, wherein the at least one adapter component comprises a flexible material with a young's modulus ranging from about 7 MPa to about 500 MPa.

17. The trailing edge adapter component of claim 15, further comprising a plurality of protrusions towards the second side portion for locating the rigid acoustic segments.

18. The trailing edge adapter component of claim 15, further comprising a plurality of recess portions for attaching the rigid acoustic segments.

19. A method comprising:
positioning a first side of at least one adaptor component over at least a portion of a trailing edge of a wind turbine blade,
attaching at least one rigid acoustic segment to an opposing second side of the at least one adaptor component for mitigating noise during fluid flow over the wind blade; and
fastening or bonding the at least one adaptor component to the trailing edge of the wind turbine blade.

20. The method of claim 19, wherein the attaching of the at least one rigid acoustic segment occurs prior to positioning the at least one adaptor component over at least a portion of the trailing edge.
